(19) United States
(12) Patent Application Publication
(10) Pub. No.: US 2004/0145667 A1
(43) Pub. Date: Jul. 29, 2004

(54) Circuit arrangement, image-sensor device and method for reducing the smearing effect on an image sensor

(76) Inventors: Uwe Apel, Neckartaiflingen (DE); Ulrich Seger, Warmbronn (DE); Roger Bauer, Reutlingen (DE); Christiane Henno Schafhauser, Tuebingen (DE)

Correspondence Address: KENYON & KENYON, ONE BROADWAY, NEW YORK, NY, 10004, US

(21) Appl. No.: 10/477,072

(22) PCT Filed: May 11, 2002
(86) PCT No.: PCT/DE02/01706

(30) Foreign Application Priority Data
May 16, 2001 (DE) 101 23 853.3

(51) Int. Cl. H04N 5/335

(52) U.S. Cl. 348/301; 348/294

(57) ABSTRACT

A circuit arrangement, an image-sensor device, and a method are proposed, the streaking effect, in particular, being greatly reduced in a dark scene of an image sensor.

### BACKGROUND INFORMATION

An image-sensor cell (image-processing sensor cell) and, respectively, a circuit arrangement for such a cell are already known from the publication WO 97/02529. It describes a circuit arrangement that provides for a high-speed reading out of image information from an image cell for an image-recorder chip.

### SUMMARY OF THE INVENTION

The circuit arrangement, the image-sensor device, and the method having the features of the coordinated independent claims, in accordance with the present invention, have the advantage over this related art of making it possible to attain the resolution required for rapidly changing scene contents having great differences in brightness and to simultaneously display substantial differences in brightness within one scene. Such great differences or rapid changes in brightness are caused, for example, by rapid changes in the viewing angle of the video sensor (such as when a motor vehicle enters into shadows when traveling through an underpass) or by bright foreign objects in motion, such as automobile headlights against a dark background. This means that there should not be any memory effects or long term effects for the individual picture element. From the above-mentioned publication, it is known to logarithmically compress the intensity signal in the individual image cell. In this way, differences in contrast occurring in the scene are kept constant for different illumination situations, in spite of substantial differences in brightness being displayed. The substantial dynamic performance that this allows further simplifies the system design, since the need is eliminated for diaphragm aperture control and exposure-time control. The disadvantage of the known related art is that the logarithmic compression within the image cell has self-adjusting, intensity-dependent integration performance characteristics that have an adverse effect on the process of recording rapidly changeable processes at low illumination. The proposed circuit arrangement and image-sensor device do not have such adverse characteristics, since a reverse voltage that is constant in all operating states is provided at the photodiode by a feedback circuit. This eliminates any recharging phenomena and the disruptive high time constants associated therewith.

It is also advantageous that the connection is switched between the electrodes of the transistor, and the amplifier. This enables, in particular, an amplifier to be used for a multiplicity of circuit arrangements in accordance with the present invention, the amplifier being connected in series to different circuit arrangements, one after another, at low impedance, so that the amplifier is used to evaluate or read out the circuit arrangement being considered.

The measures delineated in the dependent claims render possible advantageous embodiments of and improvements to the circuit arrangements, the image-sensor device, and the method according to the present invention recited in the coordinated independent claims.

### BRIEF DESCRIPTION OF THE DRAWING

An exemplary embodiment of the present invention is illustrated in the drawing and explained in detail in the following description. The figures show:

FIG. 1 an equivalent circuit diagram of a CMOS transistor connected in weak inversion operation to a photodiode;

FIG. 2 a schematic circuit diagram of the circuit arrangement underlying the present invention.

FIG. 3 the interconnection of a plurality of circuit arrangements underlying the present invention, in one column.

### DETAILED DESCRIPTION

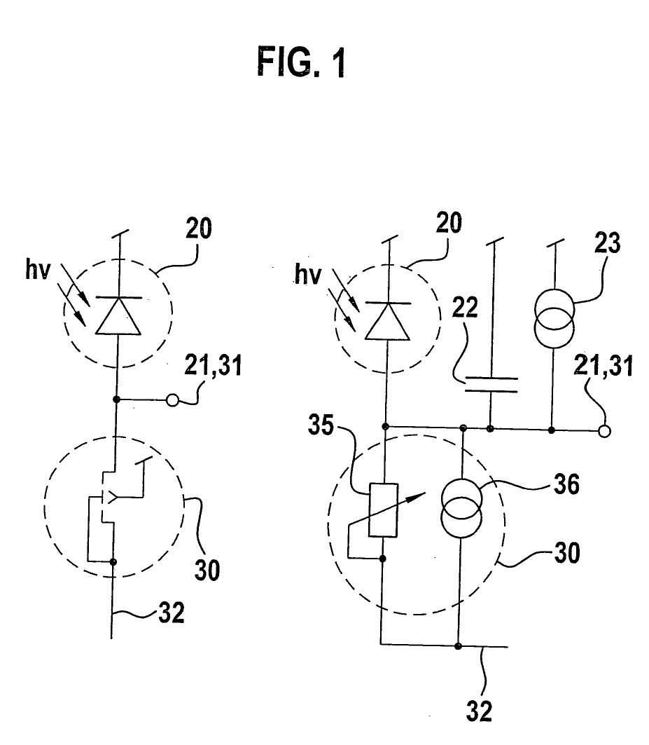

In FIG. 1, the central sensor element is shown on the left side of the figure and the equivalent circuit diagram of the central sensor element on the right side. The central sensor element includes a first transistor 30 that is provided in accordance with the present invention, in particular, as a MOS transistor or as a CMOS transistor. In accordance with the present invention, p-channel transistors are provided, in particular, which are situated in an n-well; n-channel types are likewise possible, however, in accordance with the present invention. When n-channel types are used, the voltage designations, as well as the direction of the targeted voltage displacements are reversed. First transistor 30 includes a first electrode 31 and a second electrode 32. In addition, the central sensor element includes a light-sensitive element 20 that is provided in accordance with the present invention as photodiode 20, in particular. Photodiode 20 includes a connection 21 that is connected at low impedance to first electrode 31 of first transistor 30. The equivalent circuit diagram of this central sensor element is shown on the right side of FIG. 1. Discernible, in turn, is first transistor 30, its first electrode 31 and its second electrode 32, as well as photodiode 20, along with its one connection 21. Also represented in the equivalent circuit diagram, on the right side of FIG. 1, is internal resistor 35 of first transistor 30, across which the current generated in photodiode 20 constantly drains. This is depicted by current source 36 in the equivalent circuit diagram on the right side of FIG. 1. Also shown in the equivalent circuit diagram is junction (transition) capacitance 22 of photodiode 20 and current source 23 for the dark current of photodiode 20. Internal resistor (resistance) 35 of first transistor 30 is dependent upon current intensity 36 of the traversing current. By wiring the first transistor in weak inversion operation (sub-threshold range), the photoelectric current (current source 36) is permanently shunted across internal resistor 35. The voltage drop across internal resistor 35 changes proportionally to the logarithm of photoelectric current 36. The conversion ratio corresponds to the sub-threshold slope that, in dependence upon the technology, amounts to approximately 60-100 mV per decade. The lower limit of the recordable range is also given here by the leakage current of the diode, i.e., the dark current illustrated by current source 23; the upper limit is reached when too high of a current forces the first transistor out of the sub-threshold range. By using such a wiring configuration, 6-7 decades in the light intensity are able to be recorded at ambient temperature, and, thus, evaluated.

Internal resistor 35 and junction capacitance 22 create an exposure-dependent time constant, which, particularly at low photoelectric currents, due to the increasing resistance value for internal resistor 35, is especially large and takes effect, in particular, in dark scenes. In the case that second electrode 32 of first transistor 30 is connected to ground, the result is a substantially delayed transient build-up to the dark output value, in which case the transient time may last up to a few seconds. This leads to a loss in contrast in the dark moving images. Therefore, along with an “inherent integration performance characteristic”, from second electrode 32 of first transistor 30, which is connected to ground in such a way, one has to expect the disadvantageous time response described above. Alternatively, it would be conceivable for an image cell design, including a transistor that is wired up in the sub-threshold, to be provided with an externally controlled reset algorithm that is associated with substantial and integration-restricting additional outlay. This either restricts integration or leads to additional artifacts due to the reset operation.

The present invention takes another path, namely it provides for a feedback circuit, so that a reverse voltage that is constant in all operating states is maintained at the photodiode, thereby avoiding recharging phenomena in junction capacitance 22 that would lead to disturbingly high time constants. The nodes having variable potentials are driven by an amplifier output having low enough impedance, and are fast enough. In accordance with the present invention, however, for a matrix of photodiodes interconnected in this way, a separate amplifier is not provided for each photodiode, rather, one single amplifier is provided for a whole group of photodiodes or image cells.

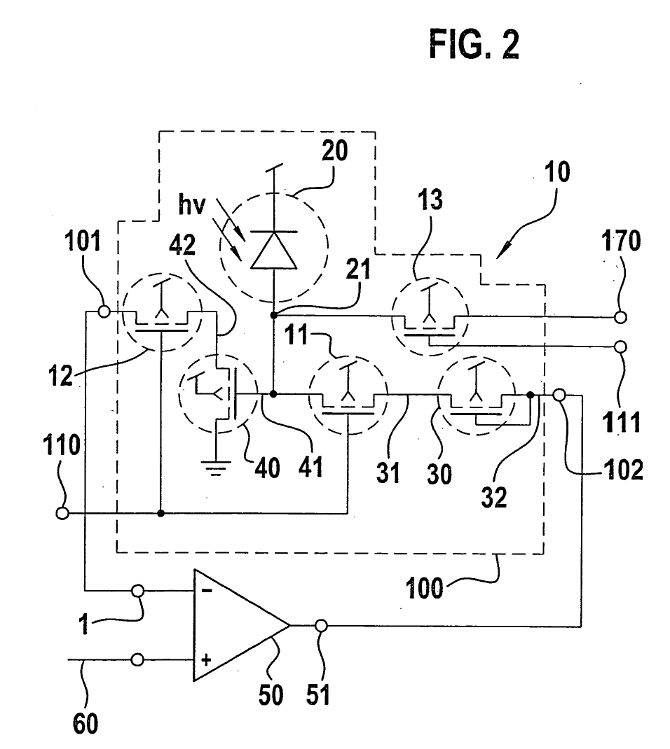

FIG. 2 illustrates a circuit arrangement 10 organized in this way. Circuit arrangement 10 includes light-sensitive element 20 or photodiode 20, first transistor 30 and a second transistor 40. The first transistor includes a first electrode 31 and a second electrode 32. Second transistor 40 likewise includes a first electrode 41 and a second electrode 42. Photodiode 20 or light-sensitive element 20 includes connection 21. In addition, circuit arrangement 10 includes a first further transistor 11, a second further transistor 12, and a third further transistor 13, further transistors 11, 12, 13 being provided as switches. Together, connection 21 of photodiode 20 and first electrode 41 of second transistor 40 form a node, which is also described as the free electrode of the photodiode. In the case that first further transistor 11 is switched through, a low-impedance connection is established between first electrode 31 of the first transistor and the free electrode of photodiode 20. In this case, the connection described in connection with FIG. 1 results between first electrode 31 of first transistor 30 and photocell 20 or its connection 21. Circuit arrangement 10 also includes a first image cell 100 which includes the components of region 100 drawn in with a dotted line. First image cell 100 has a first connection 101, a second connection 102, a third connection 110, a fourth connection 111, and a fifth connection 170. Third connection 110 of first image cell 100 is connected to the control electrodes of both first further transistor 11, as well as of second further transistor 12, so that, given an appropriate voltage state at third connection 110, both first further transistor 11, as well as second further transistor 12 switch through. When second further transistor 12 switches through, a low-impedance connection is established between second electrode 42 of second transistor 40 and first connection 101 of first image cell 100. Fourth connection 111 of image cell 100 is connected to the control electrode of third further transistor 13, and a corresponding voltage state at fourth connection 111 of first image cell 100 switches through third further transistor 13, which establishes a low-impedance connection between fifth connection 170 of first image cell 100 and free electrode 21, 41. Second connection 102 of first image cell 100 is connected at low impedance to second electrode 32 of first transistor 30. In accordance with the present invention, circuit arrangement 10 is provided in such a way that second electrode 42 of second transistor 40 is connectible at low impedance to a first input 1 of an amplifier 50. This is achieved in accordance with the present invention in that, for one thing, first connection 101 of first image cell is connected to first input 1 of amplifier 50, and a low-impedance connection is achieved between first connection 101 of first image cell 100 and second electrode 42 of second transistor 40 by switching through second further transistor 12, i.e., by way of an appropriate voltage level at third connection 110 of first image cell 100. In addition, in accordance with the present invention, second connection 102 of first image cell 100 is connected at low impedance to an output 51 of amplifier 50. Amplifier 50 is provided in accordance with the present invention, in particular, as an operational amplifier, its first input 1 being the inverting input of operational amplifier 50, and a second input 50 of amplifier 50 being provided, which, for the case that amplifier 50 is provided as operational amplifier 50, is provided as non-inverting input 60 and is loaded with a reference voltage.

Because of the comparatively large structure of amplifier 50, an implementation of amplifiers 50 for each image cell 100 is not possible for the implementation of an image sensor from a multiplicity of such image cells. For that reason, in accordance with the present invention, an amplifier 50 is used for each column of a matrix of image cells arranged in lines and columns. Therefore, such a column corresponds to a group of image cells or circuit arrangements 10, for which one amplifier is provided in each instance. Amplifier 50 is provided as a feedback (regenerative) amplifier, the feedback being activated for the actively read out image cell or also image line.

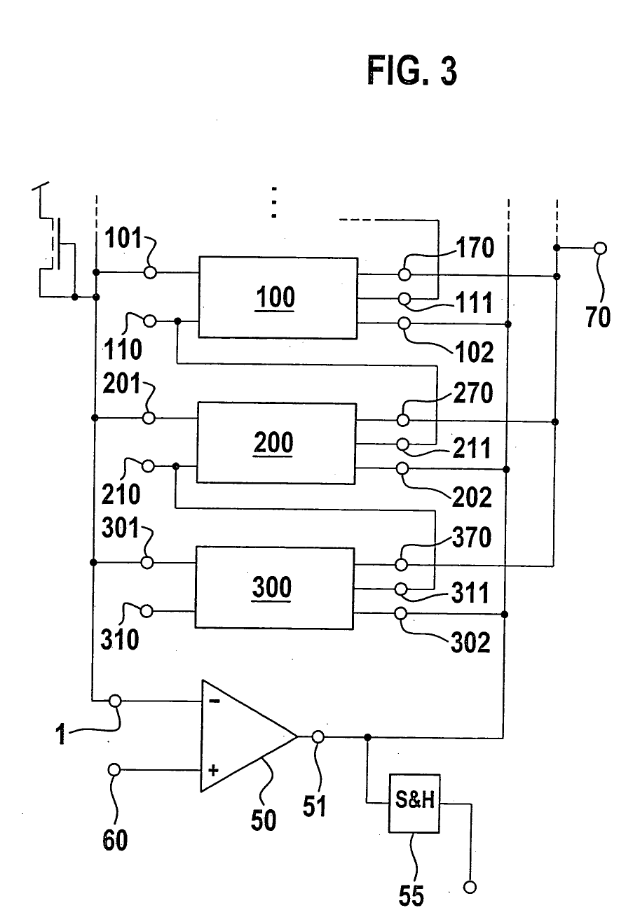

FIG. 3 shows an interconnection of a plurality of circuit arrangements 10 of the present invention in the form of a column. Here, first image cell 100 is merely shown schematically with its connections 101, 102, 110, 111 and 170. In addition, a second image cell 200 and a third image cell 300 are shown, second image cell 200, analogously to first image cell 100, including a first connection 201, a second connection 202, a third connection 210, a fourth connection 211, and a fifth connection 270. In the same way, third image cell 300 has a first connection 301, a second connection 302, a third connection 310, a fourth connection 311, and a fifth connection 370. The three image cells 100, 200, 300 are representative of a multiplicity of image cells in the array of circuit arrangements 10 interconnected in column form. Furthermore, amplifier 50 is illustrated as operational amplifier 50, together with its inverting first input 1, its non-inverting second input 60, and its output 51. Analogously to first image cell 100, first connections 100, 201, 301 of image cells 100, 200, 300 are connected to inverting first input 1 of amplifier 50. In the same way, second connections 102, 202, 302 of image cells 100, 200, 300 are connected to output 51 of amplifier 50.

The functioning of image cells 100, 200, 300 is described in the following based on the example of first image cell 100. First image cell 100 is selected by way of third connection 110 of first image cell 100. This is accomplished when using p-channel MOS transistors for further transistors 11, 12, 13, by a zero level at third connection 110, of first image cell 100. As a result, second electrode 42 of second transistor 40 and second electrode 32 of first transistor 30, together with column line of the matrix leading to negative-feedback amplifier 50, are free. The column line leading to inverting input 1 of amplifier 50 is driven by the output voltage of second transistor 40 operated as source follower that is applied to second electrode 42 of second transistor 40, first electrode of second transistor 40, which is a gate electrode, being connected to free electrode of photodiode 20. The output voltage of amplifier 50 assigned to the column under consideration settles to a value at which the voltage difference across inputs 1, 60 of amplifier 50 disappears, the potential in the line corresponding to first connection 101, thus corresponding to the externally definable, constant-over-time reference voltage level which is applied to non-inverting input 60 of amplifier 50. The potential of first electrode 41 of second transistor and—due to the switching through of first further transistor 11—also the potential of first electrode 31 of first transistor 30 or the potential of the free electrode of photodiode 20 are, consequently, lower by one threshold voltage. In this way, the shear voltage across photodiode 20 remains constant at least for the time period for which amplifier 50 is connected to second electrode 32, 42, i.e., given feedback activated via amplifier 50. In response to activated feedback, the potential at the line belonging to second connection 102 of first image cell 100 ideally settles for the period of the read-out phase, i.e., of the activated feedback, to a value at which the source-drain voltage across the first transistor working in the subthreshold range corresponds to the relation:

V_{DS}=V_{TH}+Vₛₗₒₚₑ*log(I_{DS}/I₀)

The intensity information of each individual pixel, i.e., of each individual image cell 100, 200, 300, may be read out via a column multiplexer circuit 55 which is illustrated in FIG. 3. In useful fashion, a sample & hold (S&H) circuit is used for each column, in order to render possible a time span of equal length for all columns for the transient response to the node voltage which is defined by the photoelectric current (settling phase). For the design presented here including p-channel transistors, the output voltage of the feedback amplifier changes proportionally to the logarithm of the photoelectric current, to ground. Typically, the lower limit of the output voltage range of the feedback amplifier is above the ground level. Accordingly, the potential of the free electrode of photodiode 20 is sufficiently high in order for third further transistor 13, which is likewise provided in accordance with the present invention as a p-channel transistor, to establish a sufficiently low-impedance connection to a reset voltage that is applied to fifth connection 170 of the first image cell or to all fifth connections 170, 270, 370 connected to connection 70 (shown in FIG. 3). It should be noted here that the transistor can no longer be used as a sufficiently low-impedance switch when the source-body biasing voltage of a MOS transistor is so high that it is no longer possible to build up an effective gate voltage. The reference voltage applied to non-inverting input 60 of amplifier 50 must be adjusted accordingly.

As described above, the free electrode of photodiode 20 is kept stable in terms of voltage only for as long as corresponding image cell 100, 200, 300 is addressed by third connections 110, 210, 310 and is brought into the feedback loop. Following the read-out cycle of image cell 100, 200, 300, the photoelectric current leads to a charging of junction capacitance 22 (see FIG. 1).

The present invention takes advantage of the circumstance that immediately before the subsequent read-out cycle, the free electrode of photodiode 20 may be reset via third further transistor 13, which is to be favorably integrated in the image cell arrangement and has short enough adjusting times in response to the reset voltage. It is provided, in particular, in accordance with the present invention, that, given a suitable geometric arrangement of the transistor elements, the line selection switch, i.e., the transistors corresponding to first further transistor 11 and second further transistor 12 from first image cell 100 in the transistors corresponding to image cells 100, 200, 300, from a first line are combined with the reset switches, i.e., of the transistors corresponding to third further transistor 13 from image cell 100 from the other image cells 100, 200, 300 of the subsequent line. Then, in comparison to a reset switch to be individually designed, the need is eliminated for a metallization path; given an identical pixel pitch, i.e., identical measure of repetition of image cell 100, 200, 300, a larger active surface may thus be utilized for optic sensing. For that reason, in accordance with the present invention, in a first step, light-sensitive element 20 is reset by way of a connection of the first electrode of the first transistor to the reset voltage, and, in a second step which follows in time, the connection is established between second electrodes 32, 42 and amplifier 50.

Thus, the present invention provides for such a wiring configuration and read-out method of a CMOS image-sensor cell, which is suited for operation in two-dimensionally arranged fields or arrays and in which a logarithmically compressing current-voltage conversion of the photoelectric current is carried out, the shear voltage being held to a constant voltage level corresponding up to a threshold voltage of the reference voltage, at the free electrode of photocurrent diode 20. The constant shear voltage across the pn-junction of photodiode 20 avoids the delayed discharging of junction capacitance 22, as is known of logarithmically compressing CMOS image sensors, following an incident light pulse, which is manifested pictorially as a tail of a comet or “streaking” end of the point of light. The stabilization of the diode junction depletion region voltage is effected via the feedback circuit of an amplifier 50 that is connected for each column of an image-sensor array. However, at one instant, this is only able to adjust one single image cell 100, 200, 300 of a column in terms of voltage; the potentials at the pn-junctions of remaining image cells 100, 200, 300 adjust themselves freely. Therefore, in accordance with the present invention, by way of a reset pulse applied to the control electrodes of third further transistors 13 of the particular image cells that, in time, is one line clock pulse before the line is read out, the potential at the pn-junctions tracks the stabilized voltage value of the reset voltage. Following the line change, the voltage correction at the pn-junction of photodiode 20 takes place via the first transistor operating in the subthreshold range through amplifier 50 assigned to the column.

What is claimed is:

1. A circuit arrangement (10) for a sensor cell having a light-sensitive element (20), including a first transistor (30) and a second transistor (40), one connection (21) of the light-sensitive element (20) being connectible to a first electrode (31) of the first transistor (30) and to a first electrode (41) of the second transistor (40), wherein a second electrode (42) of the second transistor (40) is connectible to a first input (1) of an amplifier (50), and a second electrode (32) of the first transistor (30) is connectible to an output (51) of the amplifier (50), a feedback being able to be produced activated by a connection of the second electrodes (42, 32) to the amplifier (50).

2. The circuit arrangement as recited in claim 1, wherein the connection is switched between the second electrodes (32, 42) and the amplifier (50).

3. The circuit arrangement (10) as recited in claim 2, wherein to switch the connection in the circuit arrangement (10), at least one first further transistor (11) and one second further transistor (12) are provided.

4. The circuit arrangement (10) as recited in one of the preceding claims, wherein an operational amplifier (50) is provided as an amplifier (50), the second electrode (42) of the second transistor (40) being connectible to the inverting first input (1) of the amplifier (50), and a reference voltage being applied to the non-inverting second input (60) of the amplifier (50).

5. The circuit arrangement (10) as recited in one of the preceding claims, wherein the first electrodes (31, 41) of the transistors (30, 40) are connectible to a reset voltage, the connection to the reset voltage being able to be provided prior to the connection to the amplifier (50).

6. The circuit arrangement (10) as recited in one of the preceding claims, wherein the first and second transistors (30, 40) are provided as MOS transistors.

7. The circuit arrangement (10) as recited in one of the preceding claims, wherein the light-sensitive element (20) is provided as a photodiode (20).

8. An image-sensor device having a multiplicity of circuit arrangements (10) as recited in one of the preceding claims, wherein the circuit arrangements (10) are arranged in groups, an amplifier (50) being provided for each group of circuit arrangements (10).

9. A method for reading out a signal from the light-sensitive element (20) from a circuit arrangement (10) as recited in one of the claims 1-8, wherein, in a first step, the light-sensitive element (20) is reset by way of a connection of the first electrode (31) of the first transistor (30) to the reset voltage, and, in a second step which follows in time, the connection is established between the second electrodes (32, 42) and the amplifier (50).
